(19) United States
(12) Patent Application Publication
(10) Pub. No.: US 2007/0089495 A1
(43) Pub. Date: Apr. 26, 2007

(54) METHOD OF INSPECTING THE PROFILE OF A CONNECTION ZONE BETWEEN A CYLINDRICAL PORTION AND A TAPER OF A TURBOMACHINE PART

(75) Inventor: Daniel Georges PLONA, Vulaines Sur Seine (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA, Paris (FR)

(21) Appl. No.: 11/551,842

(22) Filed: Oct. 23, 2006

(30) Foreign Application Priority Data
Oct. 25, 2005 (FR) 05 10850

(51) Int. Cl. G01M 1/00

(52) U.S. Cl. 73/66

(57) ABSTRACT

A method of inspecting the profile of the connection zone between the cylindrical portion and the taper of a turbomachine part, the surface profile of the part being geometrically defined by at least one first zone corresponding to the taper of the part, at least one second zone corresponding to the connection between the cylindrical portion and the taper of the part, and a third zone corresponding to the cylindrical portion of the part, the method consisting in measuring the surface profile of the part; from the measured surface profile, modeling the contact pressures that apply to the surface of the part for each of its zones; and comparing the contact pressures modeled for the second zone of the surface profile of the part with predefined threshold values.

### BACKGROUND OF THE INVENTION

The present invention relates to the general field of quality control when inspecting the profile of turbomachine parts that are subjected to contact pressures, and in particular the cylindrical rollers used in the roller bearings of a turbomachine.

Rolling bearings are commonly used in the field of aviation. In a turbomachine, rolling bearings serve in particular to support a first shaft in rotation relative to a stator or relative to a second shaft that is coaxial with the first. Such bearings are essentially constituted by balls or cylindrical rollers held in raceways formed by outer and inner rings. In general, ball bearings are used to take up axial loads while roller bearings are used to take up radial loads in a turbomachine.

The rolling elements in the bearings used in turbomachines are subjected to operating conditions that are becoming ever more severe. Although the number of failures encountered is constantly decreasing, the cost of such incidents remains high and the target of zero failures must be aimed for when designing a bearing. It has thus become necessary to further improve the reliability of roller bearings, and in particular by verifying that the profiles of their rollers are in compliance. The reliability of rolling contact in a bearing having cylindrical rollers depends in particular on the way in which forces are distributed between the two contacting surfaces, and the procedures put into place for ensuring no bearing failures must thus pass through a step of analyzing the profile of a roller. This analysis can be performed using standard instruments for measuring shapes and surfaces, such as roughness-measuring machines fitted with a diamond or laser inductive sensor, for example.

In practice, the cylindrical rollers of bearings are tapered at their ends in order to avoid excessive stresses at their ends. The connection zones between the two tapers and the cylindrical portion of such a roller can nevertheless themselves give rise to contact stresses that are unacceptable in terms of reliability of contact between the roller and the raceways. The amplitudes of such excessive stresses vary depending on the shapes of the connection zones as actually made during manufacture, and they have a direct influence on the risk of a roller flaking. Unfortunately, standard measurement equipment does not enable such connection zones to be inspected. Most instruments are limited to characterizing profiles that are simple and unique (such as profiles that are plane, circular, spherical, or cylindrical), and they are not suitable for handling combined profiles (i.e. combinations of simple profiles) in reliable manner, and they are even less suitable for handling the arbitrary profiles that can be obtained with present-day manufacturing means and that are associated with the connection zones between the tapers and the cylindrical portion of a roller. Thus, at present, quality control as applied to the connection between the different profiles of a cylindrical bearing roller does not include any quantifiable requirement.

### OBJECT AND SUMMARY OF THE INVENTION

A main object of the present invention is thus to mitigate such drawbacks by proposing a method making it possible not only to inspect the profile of the connection zone between the cylindrical portion and the taper of a roller for a roller bearing, but also to determine the suitability of an arbitrary complex shape for performing the function of distributing pressure.

To this end, the invention provides a method of inspecting the profile of the connection zone between the cylindrical portion and the taper of a turbomachine part, the surface profile of the part being geometrically defined by at least one first zone corresponding to the taper of the part, at least one second zone corresponding to the connection between the cylindrical portion and the taper of the part, and a third zone corresponding to the cylindrical portion of the part, the method consisting in: measuring the surface profile of the part; from the measured surface profile, modeling the contact pressures that apply to the surface of the part for each of its zones; and comparing the contact pressures modeled for the second zone of the surface profile of the part with predefined threshold values.

The method of the invention makes it possible to model the contact pressures that apply to the surface of the part by simple processing of the points of the profile as measured. It is thus possible to perform reliable quality control on the profile of a bearing roller, and in particular on the quality of the connection zone between the taper and the cylindrical portion of the roller.

According to an advantageous disposition of the invention, the measured surface profile of the part is in the form of a plurality of digital signals obtained by a roughness-measuring machine, said signals being processed to obtain a plurality of points having geometrical coordinates representing the geometrical surface profile of the part.

According to another advantageous disposition of the invention, for an application to a bearing roller, prior to the step of modeling the contact pressures, a potential zone of contact between the roller and its raceways is generated by rotating the measured surface profile about a longitudinal axis of the roller.

According to another advantageous disposition of the invention, the step of modeling the contact pressures is based on calculating surface pressures for contact between two elastic bodies.

The predefined threshold values are preferably a function of contact pressures modeled for the third zone of the surface profile of the part. Furthermore, the predefined threshold values are advantageously a function of the axial length of the part.

### BRIEF DESCRIPTION OF THE DRAWINGS

Other characteristics and advantages of the present invention appear from the following description made with reference to the accompanying drawings which show an embodiment having no limiting character. In the figures:

FIG. 1 is a diagrammatic profile view of part of the surface of a roller for a turbomachine roller bearing;

FIG. 2 is a flow chart showing the various steps in implementing the method of the invention;

FIG. 3 is a graph showing how the contact overpressure as the surface of the roller varies as a function of the connection radius between the tapers and the cylindrical portion of the roller; and

FIG. 4 is a graph showing how the contact overpressure at the surface of the roller varies as a function of its cylindrical length.

### DETAILED DESCRIPTION OF AN IMPLEMENTATION

In the description below, the context is that of inspecting the profile of the surface of a cylindrical roller for a turbomachine roller bearing. Nevertheless, the invention is applicable to inspecting the profiles of the surfaces of turbomachine parts other than rollers, whenever such parts are subjected to contact pressures and include a cylindrical portion connected to a taper (this could apply for example to blade roots where accurate profiles are essential).

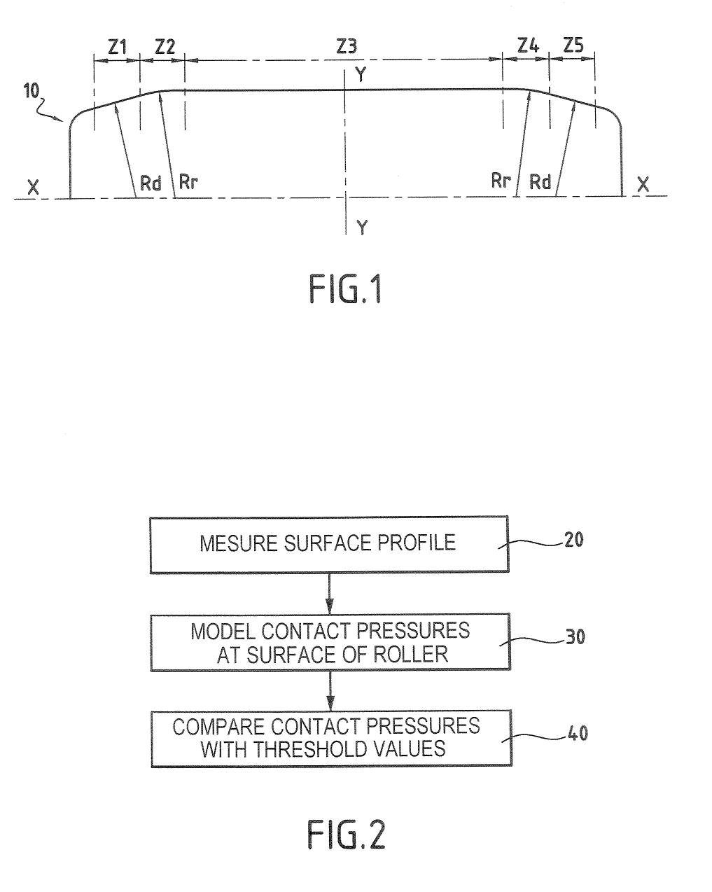

As shown in FIG. 1, it is assumed initially that the surface profile of a cylindrical roller 10 for a turbomachine roller bearing can be defined geometrically as follows: two first zones Z1 and Z5 corresponding to two tapers of the roller; two second zones Z2 and Z4 each corresponding to the connection between the cylindrical portion and a respective one of the tapers of the roller; and a third zone Z3 correspond to the cylindrical portion of the roller.

The cylindrical roller 10 is symmetrical, firstly about its longitudinal axis X-X (only half a roller is shown in FIG. 1), and secondly about a mid-plane Y-Y perpendicular to its longitudinal axis X-X. The first zones Z1 and Z5 and the second zones Z2 and Z4 of the roller are symmetrically disposed about the mid-plane Y-Y of the roller. In addition, the first zones Z1 and Z5 and the second zones Z2 and Z4 of the roller present profiles that are substantially circular with respective radii Rd and Rr, whereas the profile of the third zone is substantially rectilinear.

FIG. 2 shows the steps in a particular implementation of the method of the invention for inspecting a profile.

In general, the profile inspection method of the invention can be implemented by means of a computer system, in particular a system such as a computer workstation running software for processing digital data and connected to an instrument for measuring the surface profile of a geometrical part.

In a first step (20) of the method, the operator measures the surface profile of the cylindrical roller under inspection. This measurement can be performed using a standard roughness-measuring machine, such as a measuring appliance having a diamond or laser inductive sensor, for example. In such appliances, a sensor is secured to a moving support arm capable of moving in such a manner as to cause the sensor to follow the surface profile of the roller under inspection.

The measured surface profile is then presented in the form of signals indicative of the position of the sensor as it moves along the surface of the roller. These signals are transmitted to the computer workstation which is connected to the sensor, and they are digitally processed therein to obtain a plurality of points having geometrical coordinates representative of the geometrical profile of the surface of the roller under inspection.

From the geometrical points as obtained in this way, the potential contact zone between the roller and its raceways is generated by rotating the surface profile about the longitudinal axis X-X of the roller.

The following step (30) then consists in modeling the contact pressures applied to the surface of the roller in each of its geometrical zones Z1 to Z5, i.e. the pressures acting between the surface of the roller and the raceways. This step can be performed using computer software running on the computer workstation.

Modeling the contact pressures that apply to the surface of the roller consists essentially in calculating the surface pressures for contact between two elastic bodies. The principle used for calculating the pressure field relies on discretization of the surfaces of the two bodies, and writing equations for geometrical probabilities (the surface do not interpenetrate) and for equilibrium between the pressures acting on said surfaces (the principles of action and reaction). Writing such equations requires knowledge of the shape of the surfaces before and after deformation, and thus of the displacements under load of the various points of the surfaces that can potentially come into contact.

The coefficients that enable the displacements to be calculated as a function of the pressure field are given by Boussinescq relationships. In order to calculate these coefficients, the main assumptions are as follows: the surfaces are made of materials of the same kind, the volumes are considered as being semi-infinite solids, and the deformations, distances, and directions of loads are perpendicular to a contact plane. The geometrical relationship between the surfaces is then as follows:
Yᵢ=Eᵢ+Dᵢ^{A}+Dᵢ^{B}+Sₚ
where:
Yᵢ: distance between deformed surfaces;
Eᵢ: distance between non-deformed surfaces;
Dᵢ^{A}: deformation of the surface A;
Dᵢ^{B}: deformation of the surface B; and
Sₚ: overall approach of the surfaces (constant).
   The deformations of the surfaces are then such that:
   Dᵢ^{A}=(K^{A})×Pᵢ^{A} and Dᵢ^{B}32 (K^{B})×Pᵢ^{B}
   in which K^{A} and K^{B} are geometrical influence coefficients (that are proportional to the topology of the surface relative to the load).

On the principle of action and reaction, the relationship Pᵢ^{A}=Pᵢ^{B}=Pᵢ is established for each point of the surface.

In the contact zone between the two surfaces, the contact pressures are then determined by solving the following equations:
Yᵢ=0; Pᵢ>0; and ΣPᵢ×DS=W;
where W is the load normal to the contact, and DS is the size of the contact zone. Outside the contact zone, the following equations applies:
Yᵢ=0 and Pᵢ>0

Since the contact zone between the two surfaces is, a priori unknown, it is necessary to perform an iterative process until all of the conditions are satisfied. It is also necessary to “discretize” an area that is large enough to ensure that the entire zone of contact is included within it.

Finally, in a last step (40) of the method, the contact pressures as modeled in this way for the second zones Z2 and Z4 of the surface profile of the roller (i.e. for the connection zones between the cylindrical peripheral and the tapers of the roller) are compared with predefined threshold values. As a function of the results obtained during this comparison, the operator can decide or whether or not to retain the roller for use in a turbomachine roller bearing.

The threshold values are defined by experiment. They are selected as a function of the location of the bearing within the turbomachine, of its geometrical characteristics, of its materials, and of the external mechanical stresses to which it is subjected, and in particular the level of contact pressure between the most heavily loaded roller and the raceways.

The threshold values are preferably defined as a function of the contact pressures modeled for the third zone Z3 of the surface profile of the roller (i.e. for the zone corresponding to the cylindrical portion of the roller), and more precisely as a function of the contact pressure obtained at the center of said third zone.

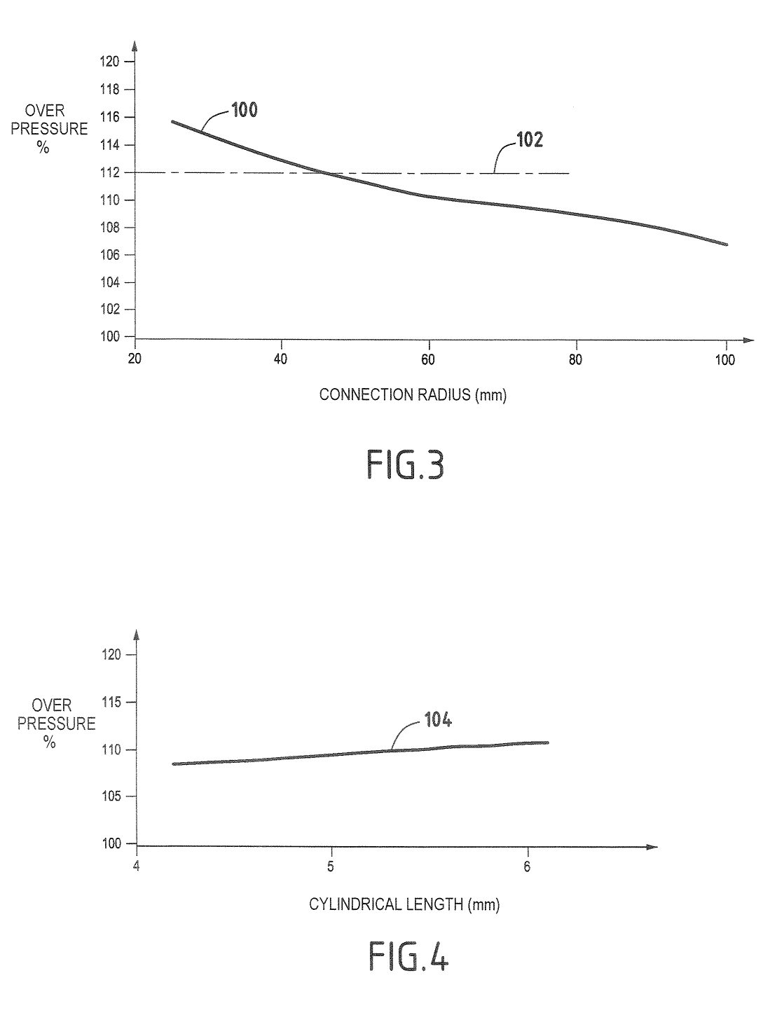

For example, the overpressure calculated for the connection zones between the cylindrical portion and one of the tapers of the roller can be expressed as a percentage of the pressure obtained at the center of the cylindrical contact zone of the roller. This overpressure must then be less than a threshold value that has been defined by experiment. FIG. 3 shows an example. In this figure, there can be seen a curve 100 representing the contact overpressure at the surface of the roller as a function of the connection radius Rr between the tapers and the cylindrical portion of a roller (i.e. of the zones Z2 and Z4 of FIG. 1). This overpressure is expressed as a percentage of the pressure obtained in the center of the cylindrical contact zone of the roller. The overpressure limit 102 as defined by experiment (in this case about 112%) represents the threshold value above which rollers should not be retained for use in a turbomachine roller bearing. This limit 102 corresponds to a connection radius Rr of the order of about 50 millimeters (mm).

Furthermore, the cylindrical portion of the roller (i.e. the zone Z3) supports a major fraction of the load applied to the roller. When the length of this cylindrical portion varies, the magnitude of the overpressure peak thus varies a little as shown in FIG. 4. This figure shows a curve 104 plotting the contact overpressure at the surface of the roller as a function of its cylindrical length. Thus, the predefined threshold values are preferably a function of the axial length of the roller. Since this influence is easy to parameterize, it is easy to add a correction for the threshold value to the calculation process.

What is claimed is:

1. A method of inspecting the profile of the connection zone between the cylindrical portion and the taper of a turbomachine part, the surface profile of the part being geometrically defined by at least one first zone corresponding to the taper of the part, at least one second zone corresponding to the connection between the cylindrical portion and the taper of the part, and a third zone corresponding to the cylindrical portion of the part, the method consisting in:
measuring the surface profile of the part;
from the measured surface profile, modeling the contact pressures that apply to the surface of the part for each of its zones; and
comparing the contact pressures modeled for the second zone of the surface profile of the part with predefined threshold values.

2. A method according to claim 1, in which the measured surface profile of the part is in the form of a plurality of digital signals obtained by a roughness-measuring machine, said signals being processed to obtain a plurality of points having geometrical coordinates representing the geometrical surface profile of the part.

3. A method according to claim 1, in which:
the part is a roller for a turbomachine roller bearing; and
prior to the step of modeling the contact pressures, a potential zone of contact between the roller and its raceways is generated by rotating the measured surface profile about a longitudinal axis of the roller.

4. A method according to claim 1, in which the step of modeling the contact pressures is based on calculating surface pressures for contact between two elastic bodies.

5. A method according to claim 1, in which the predefined threshold values are functions of contact pressures modeled for the third zone of the surface profile of the part.

6. A method according to claim 1, in which the predefined threshold values are functions of the axial length of the part.
